(19) United States
(12) Patent Application Publication
(10) Pub. No.: US 2012/0022913 A1
(43) Pub. Date: Jan. 26, 2012

(54) Planogram Generation for Peg and Shelf Items

(75) Inventors: Jacob A. Volkmann, Bloomington, MN (US); Ralph E. Thoman, Lakeville, MN (US); Liju C. Paul, Brooklyn Park, MN (US); George Varughese, Maple Grove, MN (US); Lisa A. Miller, Roseville, MN (US)

(73) Assignee: Target Brands, Inc., Minneapolis, MN (US)

(21) Appl. No.: 12/840,099

(22) Filed: Jul. 20, 2010

(51) Int. Cl. G06Q 10/00

(52) U.S. Cl. 705/7.29; 705/28

(57) ABSTRACT

In one embodiment of a computer-implemented method, layout data and product data is collected and a planogram development module processes this data to create multiple test planograms for a display space. Multiple potential planograms may be created by placing merchandise in a planogram using one or more optional rules permitting deformation of non-rigid products such as bags of non-fragile items, permitting product impingement into an adjacent shelf or peg space, allowing for hanging products on a pegboard vertically adjacent to a shelf, allowing product placement a set distance from a shelf or pegboard boundary and allowing two adjacent instances of the same product where those instances are in vertical alignment. In this embodiment, an optimized planogram is selected based on the criteria of packing efficiency, sell-through index, the aggregate sell-through index of each item multiplied by the item's profit margin, and/or overall planogram profitability.

### BACKGROUND

Certain retail enterprises have multiple store locations, management teams that collect data across the multiple store locations, and planning teams that use this data to develop strategies for the future of the retail chain. Data created and used by these teams and store locations is often organized by an enterprise software system that ties the data together and provides functionality to the enterprise users.

Merchandise data, store layout data, sales forecasts, and profitability modeling are all used to determine the merchandise that should be stocked and displayed in a store at any given time. For retail chains with many store locations, each store, or group of similar stores, have aspects that affect these determinations. As such, coordinating the stocking and display of every store in a chain is often a complex task.

Planograms provide functional overviews of product display areas that aid in making the optimized use of the product display area. For example, a planogram may include a schematic drawing of shelves and fixtures that maps optimized product placement on shelves and other fixtures in a retail store. The creation and use of planograms by a retail chain allows for consistent and efficient communication between management, planning team members, and store employees stocking shelves.

Additionally, planograms allow for a separation of duties. A planning team member with education, training, and experience in sales and marketing may develop a planogram that is thereafter transmitted to a store employee who implements the specified product display in the retail environment.

### SUMMARY

In one embodiment of a computer-implemented method, layout data and product data are collected and a planogram development module processes this data to create multiple test planograms for a display space. Multiple potential planograms are created by placing merchandise in a planogram using one or more optional rules permitting deformation of non-rigid products such as bags of non-fragile items, permitting product impingement into an adjacent shelf or peg space, allowing for hanging products on a pegboard vertically adjacent to a shelf, allowing product placement a set distance from a shelf or pegboard boundary, and allowing two adjacent instances of the same product where those instances are in vertical alignment. In this embodiment, multiple proposed planograms are developed within the constraints imposed by the selected set of rules and various metrics are applied to the planograms to determine which is optimized for a given purpose. In this example, a planogram is selected based on the criteria of packing efficiency, sell-through index, the aggregate sell-through index of each item multiplied by the item's profit margin, and/or overall planogram profitability.

The details of one or more implementations are set forth in the accompanying drawings and description below. Other features, objects, and advantages will be apparent from the description and drawings, and from the claims.

### DESCRIPTION OF DRAWINGS

FIG. 1 shows an example system for generating and distributing planogram documents to retail stores.

FIG. 2 shows an example computer system for generating planograms.

FIG. 3 shows a flowchart of an example process for generating a planogram.

FIG. 4 shows an example swim lane diagram of a process for creating a collection of planograms for a retail store.

FIG. 5 shows an example planogram.

FIG. 6 is a block diagram of a computing system optionally used in connection with computer-implemented methods described in this document.

Like reference symbols in various drawing indicate like elements.

### DETAILED DESCRIPTION OF ILLUSTRATIVE IMPLEMENTATIONS

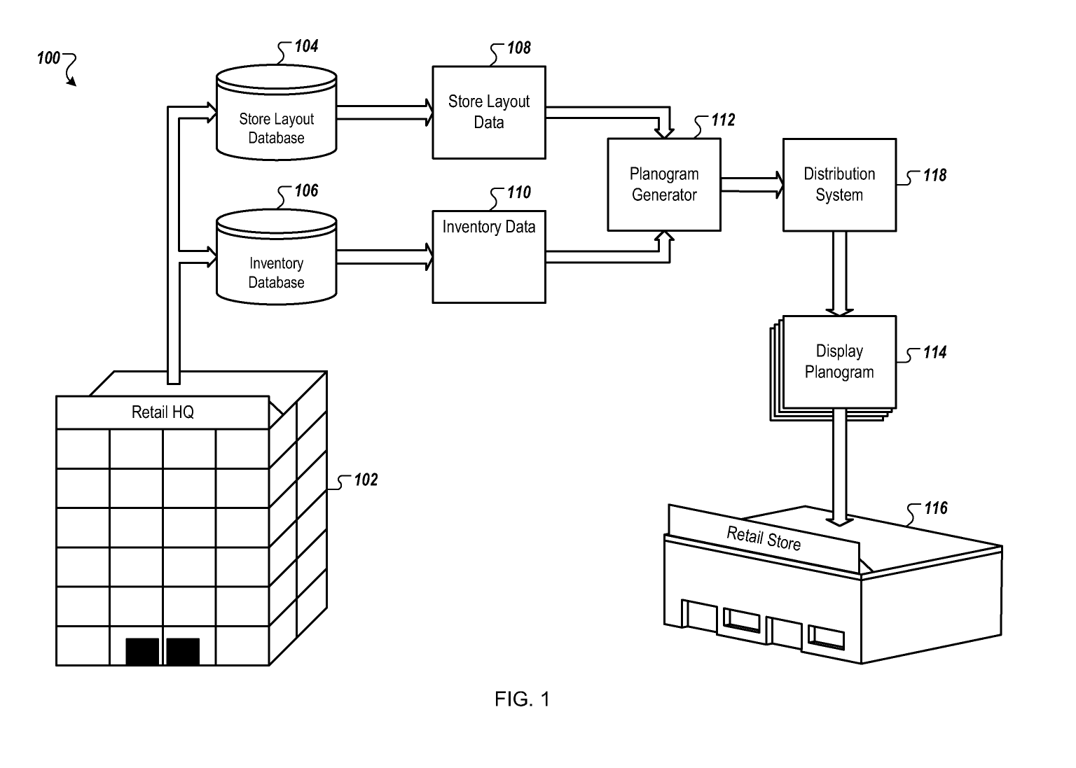

FIG. 1 shows an example system 100 for generating and distributing planogram documents to retail stores. In the system 100, data about a retail store 116 is used to generate planograms that describe product display layouts in the retail store 116. In the example system 100, the data about the retail store 116 is stored at a corporate headquarters 102, such as in an office building in a city other than the one in which the retail store 116 is located.

A store layout database 104 and an inventory database 106 contain information about multiple retail locations, including the retail store 116. The store layout database 104 includes store layout data 108, which describes the aisles, shelving, pegboard displays and other layout information of the retail store 116. The inventory database 106 includes inventory data 110, which describes the size, shape, count, and other information about inventory associated with the retail store 116.

A planogram generator 112 uses the store layout data 108 and the inventory data 110 to generate one or more planograms 114 for the retail store 116. Planograms, in this example, are product placement scenarios or diagrams of fixtures and products that illustrate how and where retail products should be displayed in a retail environment. The planograms 114 optionally include placement information for deformable products, for products that impinge onto adjacent shelf or peg space, and for products placed on peg space vertically adjacent to shelves. The planograms 114 also optionally include placement information specifying that duplicate products be placed above and below a height threshold. In some implementations, placement information is defined so that product placement does not occur on a seam or border of a pegboard. In the present example, the planogram generator 112 creates multiple intermediary planograms for each display space and selects the optimized planogram for each display space. The planograms 114 are optionally optimized for packing efficiency, sell-through index, margin of inventory, and/or overall scenario profitability.

The planograms 114 are transmitted to the retail store 116 via a distribution system 118 such as the internet, a wide or local area network, or a parcel delivery service. At the retail store 116, the planograms 114 are printed and used by store personnel to guide the placement of products on fixtures in a retail environment.

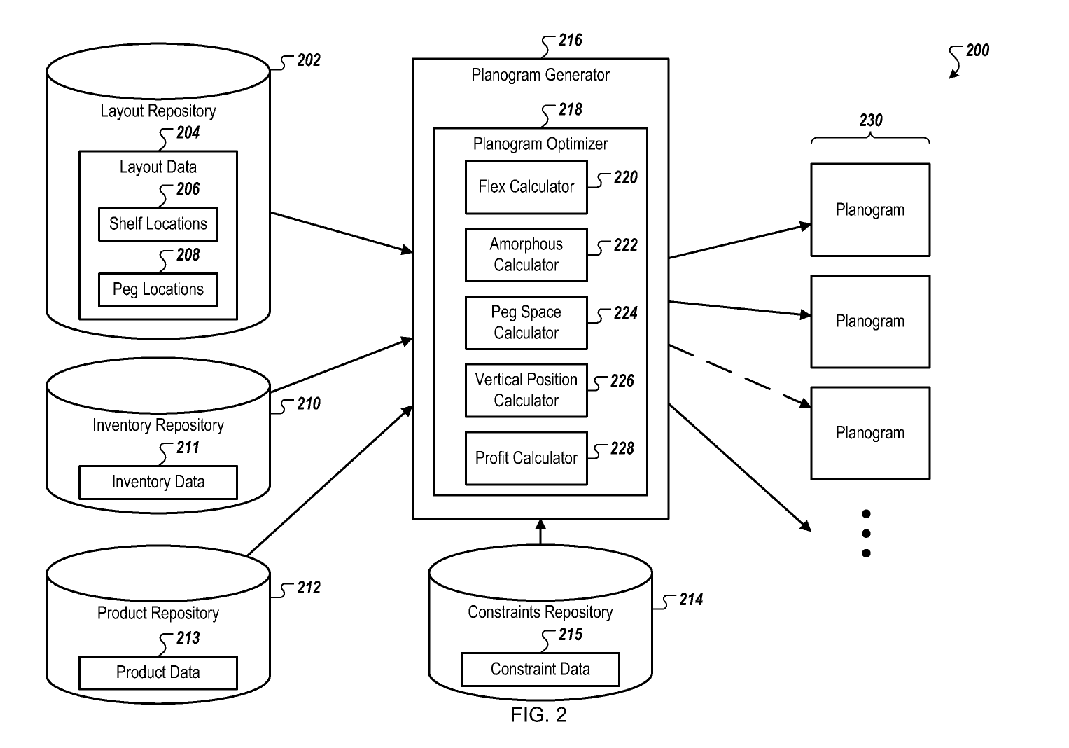

FIG. 2 shows an example computer system 200 for generating planograms. In the computer system 200, a planogram generator receives layout data 204 and product data 213 and, using a number of optimization calculations, creates a series of planograms 230. The computer system 200 is used, for example, by a retail company to create plans for displaying merchandise for sale.

A layout repository 202 contains information about retail locations, such as street address, sales metrics, and layout data 204. Each instance of layout data 204 contains information related to one retail location. The layout data 204 includes shelf locations 206, peg locations 208, and other display type locations.

An inventory repository 210 contains a retail organization's inventory data 211, such as a listing of products to be displayed for sale and equipment used for the operation of a retail location (e.g., fork lifts, signage, cash register tape, and training material).

A product repository 212 contains the retail organization's product data 213. The product data 213 includes tracking data (such as a Universal Product Code), price, profit margin, discount data, size, shape, weight, color, packaging type, deformation factor, warehouse location, count, and corresponding fixture type. The deformation factor indicates the degree to which a product can be deformed when displayed on a suitable fixture. The inventory data 211 includes information for various types of items to be displayed on a shelf or peg board, including sales products, signage, and fixtures.

A constraints repository 214 contains rules and constraints for inventory placement, including constraint data 215. The constraint data 215 include requirements for a planogram, store, product, or other feature. In one example, a planogram displaying stationery must also display pens and envelopes. In another example, a minimum number of brand options must be available for a particular item type in a planogram. In yet another example, a minimum number of copies of each item must be included in a planogram to ensure efficient inventory management.

A planogram generator application 216 receives the layout data 204 from the layout repository 202 and the inventory data 211 from the inventory repository 210. Using the inventory data 211, the planogram generator looks up the product data 213. In the example shown in FIG. 2, the layout repository 202, the inventory repository 210, the product repository 212, and the planogram generator 216 are implemented on a single computer device such as a computer server. The layout repository 202, the inventory repository 210, the product repository 212, and the planogram generator 216 are optionally implemented on separate and/or remote computer systems, and communication between the systems is optionally accomplished through any number of data transfer methods such as file transfer protocol (FTP), e-mail, enterprise middleware, and/or other methods.

The planogram generator 216 organizes relevant elements of the layout data 204 and the product data 213 for use by a planogram optimizer 218. The planogram optimizer 218 uses a number of optimization calculators 220-228 to create and select one or more planograms 230.

The planogram optimizer 218 creates a batch of planograms 230 for a single display area in a retail location. To create the batch of planograms 230, the planogram optimizer 218 uses one or more of the optimization calculators 220-228 to create each of the planograms 230 in the batch. A flex calculator 220 calculates a planogram feature with a flex factor that permits a product placement to impinge on an adjacent shelf or peg location. An amorphous calculator 222 calculates a planogram feature with a deformation factor that permits shapes representing amorphous products to deform (e.g., a bag of potato chips, a pillow, a plush animal, a towel), such as when stacked or placed adjacent to one another. A peg space calculator 224 calculates a planogram feature with a peg location vertically adjacent to a shelf, such as a product hung on a peg directly above a shelf which holds no merchandise. A vertical position calculator 226 calculates a planogram feature with a product at a peg location above an absolute vertical position and a second, identical product directly below the absolute vertical position. A profit calculator 228 determines the profitability of each planogram 230 in a batch, optionally by calculating a sell-through index for each item in the planogram. The sell-through index, which optionally incorporates the location of the product in the planogram, is an estimation of the rate at which customers will select a product for purchase. The sell-through index of each item in a planogram 230 is optionally multiplied by the profit margin of the associated item to determine the overall profitability of the planogram 230. Additionally, the profit calculator 228 optionally selects an available product placement in a planogram 230 layout that maximizes the calculation of the location-based sell-through index multiplied by profitability.

The planogram generator 216 selects the optimized planogram 230 from each batch of planograms 230. The criteria for determining the optimized planogram 230 optionally include sell-through index, overall profitability, packing efficiency (e.g., least shelf space used, least wasted space), lowest cost of fixtures required, and fewest changes for current display layout.

The collection of selected planograms 230 is outputted by, for example, saving to computer disk or printing and organized according to business needs. The selected planograms 230 are indexed by store department, saved to a Compact Disc (CD), and mailed to a retail store where the planograms 230 will be used to display merchandise. In another example, the selected planograms 230 are transmitted via an enterprise software system to a retail store.

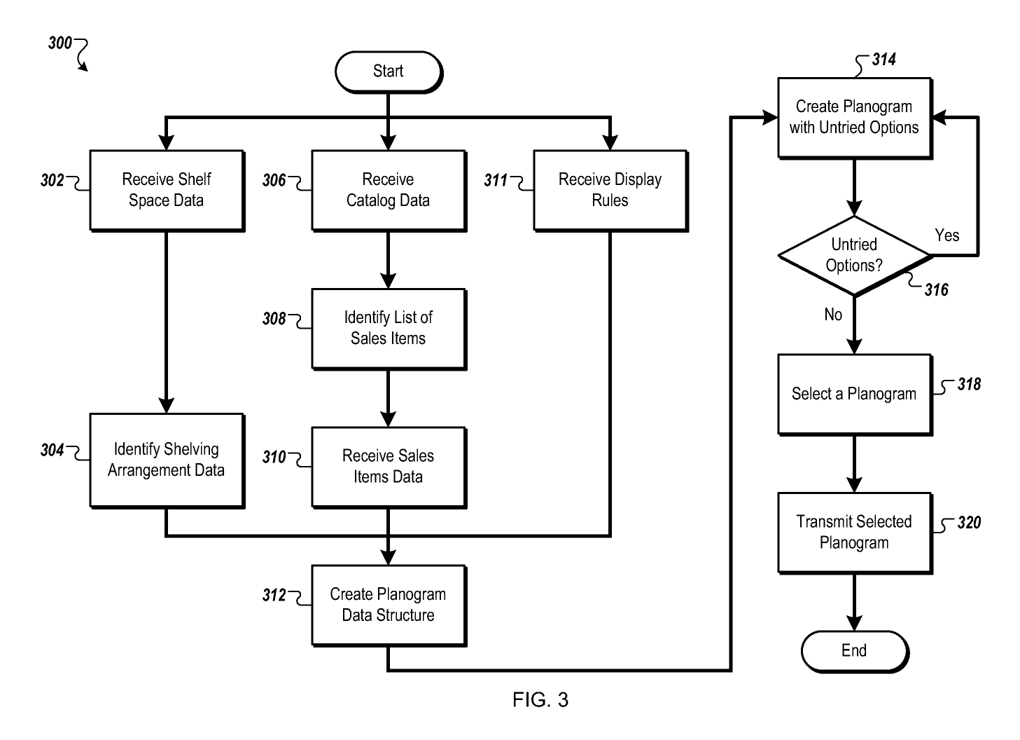

FIG. 3 shows a flowchart of an example process 300 of generating a planogram. The process 300 is performed by, for example, a computer system executing a planogram creation application.

A request for shelf space data is transmitted and shelf space data is received (302). The request optionally includes a specification for a particular retail store, a particular department in a retail store, or a particular display in a retail store. Shelving arrangement data is identified in the shelf space data (304). In this example, the shelf space data optionally includes multiple shelving arrangements, either as mutually exclusive alternatives or as multiple display units. A single shelving arrangement is identified for which a planogram is generated. In some examples, information concerning peg or shelving fixtures, such as hooks and bars, are included in the shelf space data.

In parallel with the steps 302 and 304, a request for catalog data is transmitted and catalog data is received (306). The request for catalog data optionally includes a specification for a particular retail store, for a particular department in a retail store, or for a particular display in a retail store. The catalog data includes items used by a retail store in the store's operations, including retail items that are sold by the retail store. A list of retail items is identified in the catalog data (308). A request for retail item data, based on the list of retail items, is transmitted, and retail item data is received (310). The retail item data includes an associated size, shape, orientation, and fixture type on which the item is to be displayed (e.g., shelf and/or pegboard).

In parallel with the steps 302-310, a request for display rules is transmitted and display rules are received (311). The display rules represent goals or criteria associated with an element of the planogram. For example, for a planogram to be generated for a store with a high demand for fresh produce, a minimum assortment of produce can be received.

After identifying the shelving arrangement data and the retail item data, a planogram data structure is created to store temporary planograms (312). In this example, an executing program allocates hard disk space as a hash table to store the temporary planograms. Other methods of creating a data structure are possible, including the creation of random access files, instantiation of a relational database, or the allocation of a linked list.

A temporary planogram is created with an untried option or with an untried combination of options (314) and stored in the planogram data structure. Additional planograms are created for all untried options and untried combinations of options (316) and stored in the planogram data structure. Using one or more creation options in the creation of a planogram provides for placement of items in a way that is not available in the creation of planograms without those creation options. For example, a planogram created with a deformation factor option allows for different spacing of retail items than in a planogram created without the deformation option. Table 1 below shows a listing of planogram parameters. In some implementations, one or more options are mandatory. For example, in some situations a legal guideline exists to the effect that any retail item hung on a pegboard above a certain height must have an identical item vertically adjacent and below the height threshold. In such examples, a corresponding vertical alignment constraint is imposed during each repetition of step 314.

TABLE 1
Planogram Parameters

| Option | Description |
|---|---|
| Deformation | Factor by which a retail item shape is adjustable or |
| Factor | deformable in order to pack or stack the retail item |
| Flex Factor | Factor by which a retail item impinges on an adjacent |
| | shelf location or peg location |
| Shelf Vertical | Option to permit a retail item hanging on a peg |
| Adjacency | vertically adjacent to a shelf, such that no other |
| | retail item is placed on the shelf |
| Seam Boundary | Option to permit items to be hung on a pegboard |
| | on a seam boundary (the abutment of two |
| | parallel fixture edges) |
| Item Above | Option to ensure that, when a retail item is placed |
| Vertical Position | above an absolute vertical position at a peg location, |
| | another retail item of the same type at a vertical |
| | position below a predetermined height threshold |

A planogram is selected from the planogram data structure (318). In this implementation, the planograms in the planogram data structure are sorted according to a selection value and all planograms except one with the highest selection value are deleted. The selection value is optionally calculated based on a planogram's profitability or sell-through index.

The planogram is transmitted to the associated retail store (320). In this example, the planogram, along with other planograms generated in a similar manner and for the same store, are printed into a portable document format (PDF) file. The multiple copies of the PDF file are printed to paper and the copies are bound in three-ring binders. The binders are packed into shipping boxes and shipped via parcel mail to the retail store. In other examples, other methods of transmission are possible.

A number and order of steps are described for this example. However, a different number, order, and type of steps are possible to generate a planogram. In some alternative implementations, only a single planogram is created for a shelving arrangement. In some of these implementations, products are placed into the planogram at certain locations according to placement criteria such as sell-through index, location-specific sell-through index and/or margin of the product. In some implementations, the steps 314 and 316 are performed by another method, such as by a mixed integer solver that creates a single planogram.

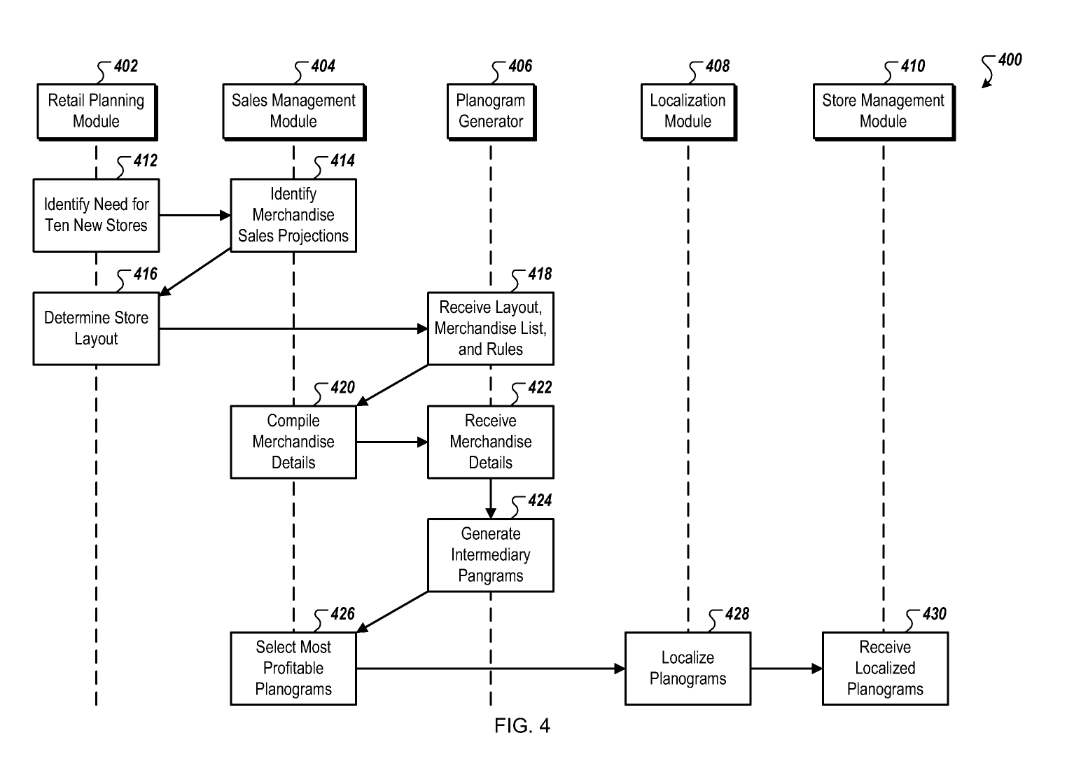

FIG. 4 shows an example swim lane diagram of a process 400 of creating a collection of planograms for a retail store. In the process 400, a retail chain enterprise software system is used to plan an expansion that involves the opening of ten similar retail locations. A retail planning module 402 is a software module used to plan financial and logistical activities of operating a retail chain. A sales management module 404 is a software module used to manage the sale of merchandise in a retail chain. A planogram generator 406 is a software module used to generate planograms for displaying merchandise in a retail store. A localization module 408 is a software module used to localize documents into a local language or dialect and to change features in the document that are inapplicable for a particular location. A store management module 410 stores and processes documents and events related to a particular retail store.

A business need for ten new stores is here identified (412) at the retail planning module 402. Information such as population studies, changes to real estate and supplier costs, and infrastructure projects, present business opportunities that suggest expansion. The sales management module 404 uses historical data sales and information provided by the retail planning module 402 to identify merchandise sales projections 414 for the ten new stores. In this example, the retail planning module defines the ten new stores as substantially similar, and thus, the sales management module 404 identifies a single sales projection that is used for all ten expansion stores. Similarly, the retail planning module 402 determines a single store layout (416) for use by all ten expansion stores.

The store layout, merchandise list, and rules are sent to the planogram generator 406 (418). The sales management module 404 compiles a list of merchandise details (420) for all merchandise in the merchandise list. The merchandise details are received by the planogram generator 406 and paired with the merchandise list (422).

The planogram generator generates a collection of intermediary planograms for each display location (424) in the expansion store. The collection of planograms is created by enabling one or more features of the planogram generator for each planogram in the collection and adding merchandise to the planogram until the planogram for that display location is full. After each collection is complete, the sales management module 404 determines a most profitable planogram (426) for that display location and the other planograms are discarded.

The collection of selected planograms is copied, one for each store, and localized by the localization module 408 (428). The localization module here translates the documents into Spanish for two stores located in Spanish-speaking areas and, for three stores with local produce available year round, replaces the standard produce with comparable local products.

The store management modules 410 for each expansion store location receive the localized planograms 430. The planograms are reviewed by the expansion store's management, then printed and used for the initial shelf stocking when the store opens.

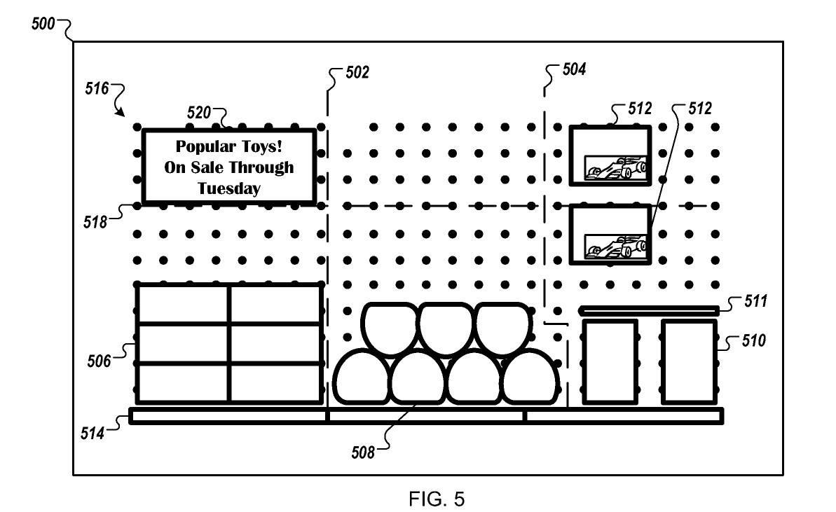

FIG. 5 is a depiction of an example planogram 500. The example planogram 500 shows products, some of which have been placed to avoid seams, based on amorphous packaging, impingement into an adjacent display space, placement on a pegboard vertically adjacent to a shelf, and/or vertical arrangement of products of the same type below a predetermined height.

The planogram 500 shows some of the toys to be displayed in a toy department of a retail store. Shelves 514 are shown along the bottom of the planogram 500 and a pegboard 516 lines the wall behind the shelves 514. Hooks and other display fixtures are attached to the pegboard to hold merchandise, such as merchandise in clam shell packaging with a hole in the top.

A puzzle 506 is a rectangular box that happens to be slightly less than half as wide as a single shelf 514. Two stacks of puzzles 506 are shown near but not touching a boundary 502 between two shelves 514.

Plastic bags 508 containing green plastic action figures are shown stacked on the shelf 514. The plastic bags 508 are shown with irregular geometry due to their flexible material and discrete contents. The irregular geometry of the plastic bags allows for stacking in a way that rectangular packages are not stackable. The plastic bags 508 are shown impinging 504 onto adjacent shelf 514 space. The plastic bags 508 are placed impinging into adjacent space, for example, because they are high margin items and placing additional bags in the planogram results in a higher net profit margin for the planogram. In an alternative example, the plastic bags are placed impinging into adjacent space because they pack more efficiently than any other product that could be placed there and the plastic bags 508 result in a more efficiently packed planogram.

A deck of cards 510 with a plastic tag for hook hanging is shown hanging from a rod 511 in the space vertically adjacent to the shelf 514. The deck of cards looks more attractive to a potential buyer when its primary surface faces outwardly and has a higher sell-through index in this configuration.

A collector's edition toy car 512 is shown hanging by hook at a peg location above an absolute vertical position 518 and a second identical toy car 512 is shown below the same absolute vertical position 518. The lower toy car 512 is placed below the absolute vertical position 518 so most customers are able to reach at least some of the toy cars 512. The higher toy car 512 is placed above the absolute vertical position 518 because the toy car 512 has a high sell-through index and a high profit margin. The inclusion of the higher toy car 512 thus increases both the sell-through index and overall profitability of the planogram 500.

A sign 520 is shown hanging at a peg location. The sign is shown on the planogram 500 in the same format as the other products with the same information available to the reader.

In this example, some portions of the pegboard 516 are left empty. The corresponding sections of the retail display area are to be filled as needed, for example, with seasonal or other inventory.

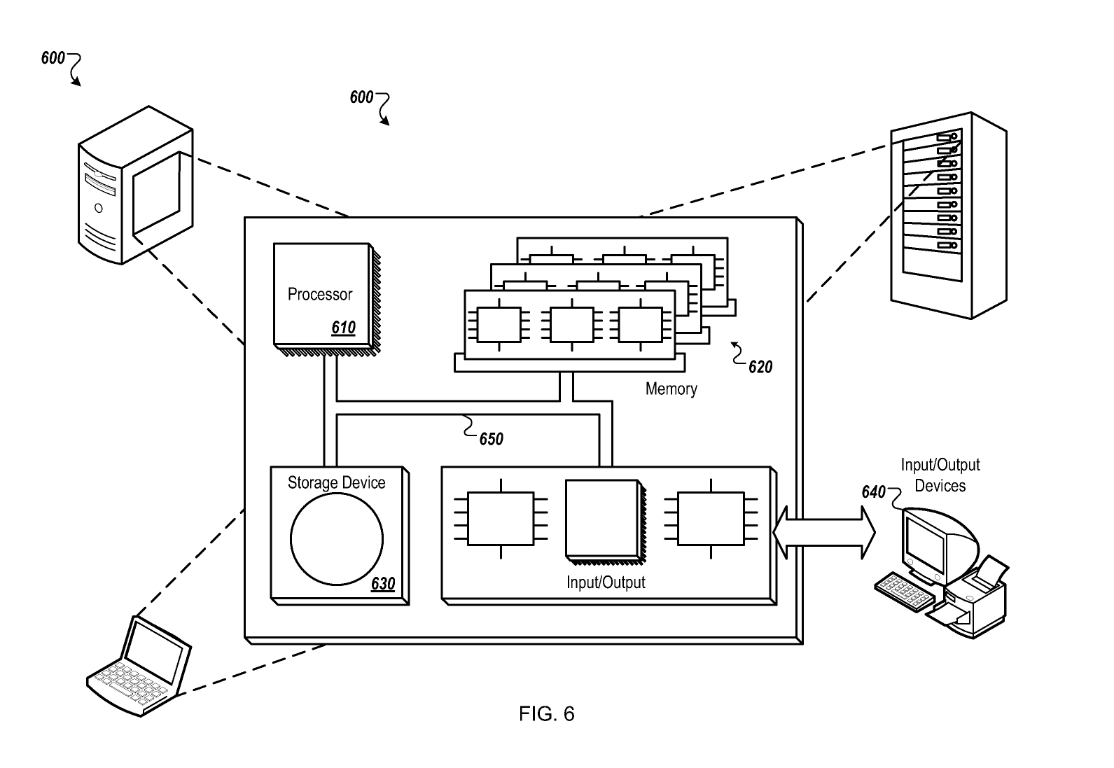

FIG. 6 is a schematic diagram of a generic computer system 600. The system 600 is optionally used for the operations described in association with any of the computer-implemented methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 is optionally a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory including, by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features, in some instances, are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications are optionally made without departing from the spirit and scope of this disclosure. Accordingly, other embodiments are within the scope of the following claims.

What is claimed is:

1. A computer implemented method for generating a product placement scenario, the method comprising:
retrieving, from a layout database, layout data including a shelving arrangement in a product display area of a retail environment, wherein the shelving arrangement includes both shelf locations and peg locations;
retrieving, from an inventory database, inventory data indicating products to be displayed in the product display area;
retrieving, from a product database, product data indicating for each of the products at least a product size, a product shape, and a corresponding fixture type;
generating a first product placement scenario in which each of the products is placed at a particular shelf location or peg location within the shelving arrangement;
generating a second product placement scenario for the products wherein at least some of the products are placed at a different shelf locations or peg locations within the shelving arrangement, wherein the second product placement scenario is based at least in part on a deformation factor of at least some of the products;
determining an optimized product placement scenario; and
transmitting the optimized product placement scenario to the retail environment for display or reproduction in a tangible medium.

2. The method of claim 1, wherein the second product placement scenario is based at least in part on a flex factor that accounts for impingement of one of the products into an adjacent shelf location or peg location.

3. The method of claim 1, wherein the second product placement scenario is based at least in part on a vertical adjacency of a peg location to shelf location.

4. The method of claim 1, wherein the second product placement scenario is based at least in part on a proximity to a boundary or seam between a first shelf location or a first peg location and a second shelf location or a second peg location.

5. The method of claim 1, wherein the second product placement scenario includes, where a first product of a first type is placed above a predetermined height threshold at a peg location, a second product of the first type at a vertical position at or below the predetermined height threshold.

6. The method of claim 1, wherein determining the optimized product placement scenario further comprises generating a third product placement scenario and a fourth product placement scenario.

7. The method of claim 1, wherein the optimized product placement scenario is determined based on a packing efficiency metric for the product placement scenarios.

8. The method of claim 1, wherein the second product placement scenario is based at least in part on a sell-through index.

9. The method of claim 8, wherein the products are placed at certain locations based on associated sell-through indices and product margins.

10. The method of claim 9, wherein the determination of the optimized placement scenario is based on an overall scenario profitability that is a function of margins and location-specific sell-through indices of the products.

11. The method of claim 1, wherein the inventory data includes data specifying signage.

12. A system for generating a planogram, the system comprising:
a display space database containing display space data including a shelving arrangement in an item display area of a sales environment, wherein the shelving arrangement includes both shelf positions and hook positions;
a merchandise database containing merchandise data indicating items to be displayed in the item display area;
an item database containing item data indicating for each of the items at least an item size, an item shape, and at least one corresponding fixture type;
a planogram generator to receive the display space data, the merchandise data, and the item data, to generate a first planogram in which each of the items is placed at a particular one of the shelf positions or hook positions within the shelving arrangement, and to generate a second planogram for the items wherein at least some of the items are placed at a different one of the shelf positions or hook positions within the shelving arrangement, wherein the second planogram is based at least in part on a shelf space adjustment factor that accounts for impingement of one of the items into an adjacent one of the shelf positions or hook positions.

13. The system of claim 12, wherein the second planogram is based at least in part on a shape distortion of at least some of the items.

14. The system of claim 12, wherein the second planogram is based at least in part on a vertical adjacency of one of the hook positions to one of the shelf positions.

15. The system of claim 12, wherein the second planogram is based at least in part on a proximity to a boundary or seam between (i) a first shelf position or a first hook position and (ii) a second shelf position or a second hook position.

16. The system of claim 12, wherein the second planogram includes, where a first item of a first type is placed above a predetermined height threshold at a hook position, a second item of the first type at a vertical position below the predetermined height threshold.

17. The system of claim 12, wherein the item data includes data related to signage.

18. A physical computer-readable medium, embodied in a device, on which medium is encoded program code configured for execution by a processor to perform a method for generating a merchandise display map, the method comprising:
retrieving, from a shelf space database, shelf space data comprising a shelving arrangement in a retail item display area of a retail environment, wherein the shelving arrangement includes both shelf locations and peg locations;
retrieving, from a catalog database, catalog data indicating retail items to be displayed in the retail item display area;
retrieving, from a retail item database, retail item data indicating for each retail item at least a retail item size, a retail item shape, and at least one corresponding fixture type;
generating a first merchandise display map in which each of the items are placed at a particular one of the shelf locations or peg locations within the shelving arrangement;
generating a second merchandise display map for the retail items wherein at least some of the retail items are placed at different shelf locations or peg locations within the shelving arrangement, wherein the second merchandise display map is based at least in part on a vertical adjacency of one of the peg locations to one of the shelf locations.

19. The computer-readable medium of claim 18, wherein the second merchandise display map is based, at least in part, on a flex factor that accounts for impingement of one of the retail item into an adjacent one of the shelf locations or peg locations.

20. The computer-readable medium of claim 18, wherein the second merchandise display map is based, at least in part, on a deformation factor of at least some of the retail items.

21. The computer-readable medium of claim 18, wherein the second merchandise display map is based, at least in part, on a proximity to a boundary or seam between a first shelf location or a first peg location and a second shelf location or a second peg location.

22. The computer-readable medium of claim 18, wherein the second merchandise display map includes, where a first retail item of a first type is placed above a predetermined height threshold at a peg location, a second retail item of the first type at a vertical position below the predetermined height threshold.

23. The method of claim 18, wherein the retail item data includes data relating to signage.
